(19) United States
(12) Patent Application Publication
(10) Pub. No.: US 2009/0144876 A1
(43) Pub. Date: Jun. 11, 2009

(54) PATIENT LIFT AND GAIT ASSISTANCE GARMENT

(76) Inventors: Armida Pena, Salem, OR (US); Karla De La Torre, Hacienda Heights, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/328,621

(22) Filed: Dec. 4, 2008

Related U.S. Application Data
(60) Provisional application No. 60/992,435, filed on Dec. 5, 2007.

(51) Int. Cl. A41D 1/04; A61G 5/00

(52) U.S. Cl. 2/102; 5/81.1 R

(57) ABSTRACT

A lift vest made of a lightweight, but strong fabric includes a comfortable neckline and armholes of a size so as to fit individuals of different sizes. Hook and loop fasteners enable the vest to be tightly secured to the individual. Multiple handle holds are attached to the exterior of the vest to enable a caregiver to support the individual or assist the individual in moving from one location to another.

### BACKGROUND OF THE INVENTION

The present invention generally relates to a garment for ambulatory patients. More particularly, the present invention relates to a lift support vest for aiding a patient to move safely about.

Many elderly or handicapped persons, and particularly persons confined to wheelchairs, are unable to stand on their own and require the assistance of one or more persons to move them from a wheelchair or other seating arrangement and to a standing position. Grasping a patient to assist him or her in moving from one position to another is difficult. Some health professionals or family caregivers grasp patients by their arms or their belts to assist in hoisting them from a wheelchair or other seated position. Others grab articles of clothing, such as a trouser seat or shirt collar. However, these garments are not designed or adapted for easy grasping, and sometimes tear, and require a strong grip on the part of the caregiver. This is not only uncomfortable for the patient, it can also cause bruising or more serious injuries.

In other cases, a patient must be taught how to walk, climb and descend steps and generally maneuver successfully on mechanical supports, or simply to learn to walk by practice on a treadmill-type device or with the help of another person. Therefore, physical therapists must be trained in the use of methods of teaching ambulation to patients and in methods of avoiding falls or accidents by patients during this training period.

Because of the difficulty of taking hold of a patient that needs to be moved from one position to another, a caregiver frequently sustains injury to himself or herself such as an injured back. Injuries to caregivers are particularly likely when it is necessary to quickly move to try to assist a patient that is falling.

Caregivers and therapists have had few assistive devices to use during periods of patient ambulatory training or when otherwise assisting an individual in walking, or moving the individual from one seated position to another, or a seated position to a standing position. The apparatus which is most utilized is a gait belt which is placed around the waist of a patient. The gait belt is a standard nursing home tool to aid in the assistance of ambulatory patients to move about. The belt is a bit wider than a normal dress belt and typically made of heavy cotton material or leather. A gait belt usually has two or three handles attached to its back and side sections. When worn by a patient, a healthcare worker or caregiver is able to grasp the belt from behind and steady those with an unstable gait or prevent a traumatic collapse should the patient fall, faint or otherwise lose balance. U.S. Pat. No. 4,396,013 to Hasslinger; U.S. Pat. No. 5,647,378 to Farnum; and U.S. Pat. No. 6,073,280 to Farnum are illustrative of such gait belts.

However, such gait belts have several drawbacks. At best, the use of the handles on a gait belt can be clumsy and ineffective if both patient and caregiver are caught in an off-centered position. The caregiver must maintain a strong stride position for the balance of both himself and his wobbly patient. Moreover, the caregiver has no way to restrain the upper body of a patient in the falling situation except to grasp at the patient's shoulder in an attempt to slow the rate of falling. If the caregiver is unsuccessful, the patient could suffer broken bones or additional bruises. Moreover, such gait belts and harnesses are uncomfortable to wear and have a tendency to slide up from the patient's waist area and to twist or torque as the patient is lifted. Because of its narrow engagement with the patient's torso, it can be very dangerous for very heavy or very small and frail patients wherein excessive forces are exerted on the sternum and ribcage, possibly causing fractures or other injuries.

There have been other devices for supporting patients. For example, U.S. Pat. No. 5,836,310 is directed to a patient-supporting gait vest. The vest is formed of a single piece of material with a hole in the center for the head and recesses that form armholes when the material is folded over the body, creating a front and back panel. The panels are connected under the armholes with zippers. The back panel includes a pair of straps attached to a diagonal to the shape of the back and intersect near the center point of the panel. A pair of handles are vertically mounted approximate the center point to the straps. However, this vest does not provide handle holds on the front of the vest, side of the vest or the like, but merely provides handle holds on the back of the vest, and thus does not provide the points of lift and support that the caregiver might need to lift the patient from a seated position or to support the patient while erect or walking. Moreover, the vest is designed to be easily placed over an individual. The downside of this is that the vest is not tightly formed to the patient and is not adjustable to patients of different sizes. Thus, it is quite possible that the vest can become loose and pulled upwardly around the arms and shoulder area of smaller patients.

U.S. Pat. No. 5,397,171 to Leach discloses a gait assistance harness apparatus. U.S. Pat. No. 6,122,778 discloses a harness system for a vest. The harnesses comprise horizontal waist and chest belts, vertical left and right shoulder straps, a horizontal upper back strap, and double belt controls all secured to each other by means of buckles and attachments. Loops or handle holds are provided at the shoulders and back and front of the individual. The buckles and strap mechanisms provide adjustability for larger and smaller patients. However, there are various drawbacks to this arrangement as well. The complicated strap arrangement can take quite some time to be properly situated on the individual and tightened. Secondly, the multiple buckles and adjustment clamps and the like render the harness arrangement uncomfortable to the patient, particularly if the patient is going to remain within the harness for a prolonged period of time.

Accordingly, there is a continuing need for a device which provides more control for a caregiver or therapist which moves a patient or loved one about and assists them in ambulatory movement. There is also a continuing need for such a device to be lightweight and comfortable for a patient to wear, yet sturdy enough to control the weight of a falling adult and still be relatively inexpensive to purchase. The device should be relatively simple in installation and use, yet accommodate individuals of different sizes so as to be easily and quickly adjusted so as to be securely held to that individual. The device should be capable of being comfortably worn for extended periods of time. The present invention fulfills these needs, and provides other related advantages.

### SUMMARY OF THE INVENTION

The present invention resides in a patient lift and gait assistance garment, which is lightweight and comfortable for a patient to wear, yet sturdy enough to control the weight of a falling adult and still be relative inexpensive to manufacture and purchase. The device is relatively simple in installation and use, and accommodates individuals of different sizes, yet can be adjusted so as to be securely held to that individual. Moreover, due to the fact that the invention does not include hard plastics, metal, or other such materials, is capable of being comfortably worn for extended periods of time.

The patient lift and gait assistance garment comprises a fabric garment having a vest configuration. The vest configuration has a back portion and a front portion. Typically, the front portion comprises a first front flap portion and a second front flap portion, the first and second flap portions being removably attachable to one another. The first flap includes a segment of hook or loop material, and the second flap includes a corresponding segment of hook or loop material for removable connection, which enables the removable connection of the first and second flaps. The front portion and back portion each have a neckline which cooperatively forms a neck opening. A first aperture is formed in the garment which defines a right arm opening. A second aperture formed in the garment defines a left arm aperture.

At least one elongated strip of fabric has first and second ends thereof attached to the front portion of the garment for forming at least one front handle hold. At least one elongated strip of fabric having first and second ends attached to the back portion of the garment form at least one back handle hold. A strip of fabric attached to the garment at generally opposite ends thereof are disposed below the right and left arm openings to form side handle holds.

The at least one elongated strip of fabric forming the back handle hold is attached to the back portion of the garment intermediate the ends thereof to form multiple back handle holds. Typically, the elongated strip of fabric extends substantially a length of the back portion. The at least one elongated strip of fabric may comprise a single strip of fabric which extends adjacent a bottom edge of the back portion at a first end thereof, to a second end adjacent to the neckline of the back portion, substantially along a mid-line of the back portion of the vest. Alternatively, the at least one elongated strip of fabric comprises a plurality of vertically oriented and spaced apart elongated strips of fabric which are attached to the back portion of the garment, and which form at least one handle hold in each strip, and preferably are attached intermediate the ends thereof to form multiple handle holds.

The at least one elongated strip of fabric which forms the at least one front handle hold typically comprises a strip of fabric vertically oriented on the first front flap, and a strip of fabric vertically oriented on the second flap. Once again, in a preferred embodiment, not only are the first and second ends of the strips of fabric, which extend substantially the length of the front and second flaps, attached to the garment, but the strips are attached intermediate the ends thereof so as to form multiple handle holds on the front of the garment.

At least one elongated strap of fabric has a first end attached to the garment, and a second end which extends from the garment, the strap having hook or loop material on a surface thereof. At least one second elongated strip of hook and loop material is attached generally along a length thereof to the front portion of the garment, whereby the free end of the at least one elongated strap of fabric is brought over and attached to the at least one elongated strip of hook and loop material so as to tighten and adjust the garment on the patient. In a preferred embodiment, the at least one strap comprises a plurality of straps, each having a first end attached to the first front flap in spaced apart relation, and the at least one strip of hook or loop material comprises a plurality of strips of hook or loop material attached to the second front flap in spaced relation corresponding to the plurality of straps, and having a generally horizontal orientation, so as to be configured to receive the straps thereon.

The invention may include a bib which is removably attached to the front portion of the garment, so as to substantially cover the first and second flaps of the front portion of the garment. Typically, hook and loop material are the fasteners for removably attaching the bib to the garment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a partial phantom view illustrating a patient seated and wearing the lift and gait assistance garment of the present invention, and a caretaker standing adjacent to the patient;

FIG. 2 is a view similar to FIG. 1, but illustrating the caretaker using the garment of the present invention to assist the patient in standing erect;

FIG. 3 is a perspective view of a patient lift and gait assistance garment embodying the present invention;

FIG. 4 is a front elevational view of the garment of FIG. 3;

FIG. 5 is a front elevational view of a garment embodying the present invention, and having front flaps thereof detached from one another, in accordance with the present invention;

FIG. 6 is a side elevational view of the garment of the present invention;

FIG. 7 is a rear elevational view of one embodiment of the garment of the present invention;

FIG. 8 is a rear elevational view of another garment embodying the present invention;

FIG. 9 is a partially exploded perspective view of the patient lift and gait assistance garment of the present invention, and a bib being attached thereto;

FIG. 10 is a front perspective view illustrating the bib attached to the garment;

FIG. 11 is a front elevational view of the bib attached to the garment; and

FIG. 12 is a side elevational view illustrating the bib attached to the garment.

### DETAILED DESCRIPTION OF PREFERRED EMBODIMENTS

The present invention provides a garment-type device in the form of a vest which is designed to enable a caretaker to safely assist a patient to move from one position to another. “Patient” is meant to mean any person irrespective of age, sex, heath condition, physical impairment or disability that requires, even if occasionally, assistance in moving. As an example, the vest 10 of the present invention is a garment that facilitates moving a patient from a wheelchair to another type of seating arrangement, such as an adjacent seat, bathroom stool, automobile, bed, etc. Further, the device is particularly useful for assisting a patient in getting out of and rising from a bed or in turning a bed patient from one position to another or assisting a patient who may be unstable when standing or walking.

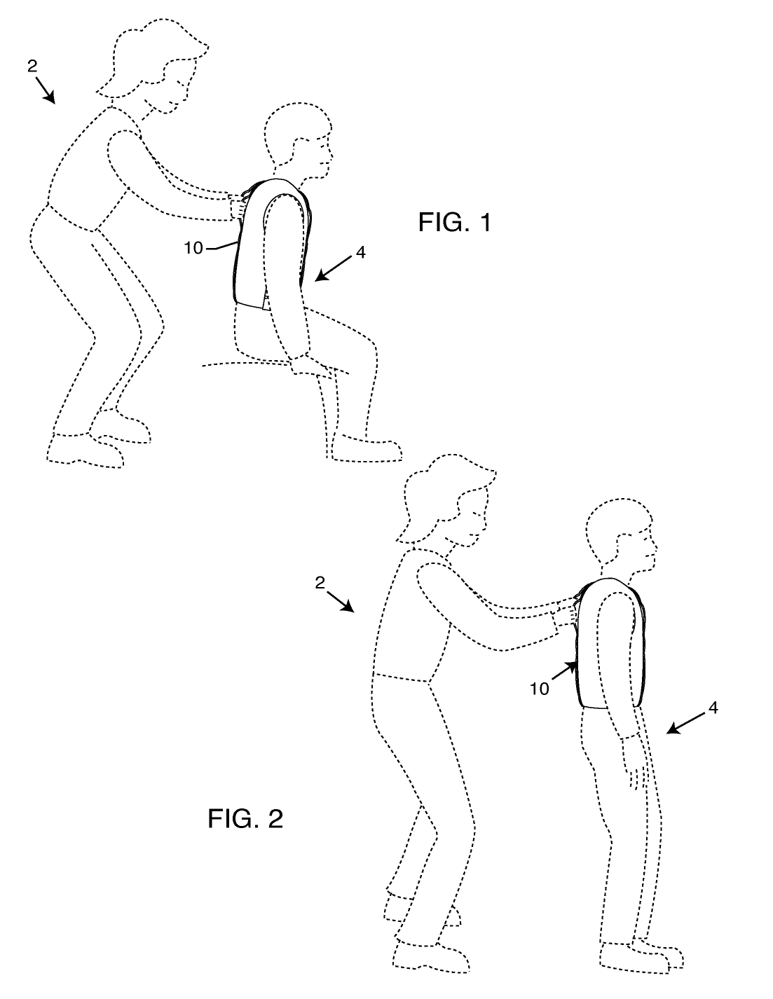

With reference now to FIGS. 1 and 2, a caretaker 2 is illustrated standing next to a patient 4 wearing the lift and gait assistance garment vest 10 of the present invention, and grasping handle holds thereof so as to assist the patient 4 in standing from a seated position. FIG. 2 illustrates the caregiver 2 pulling upwardly on the garment vest 10 of the present invention such that the patient 4 is standing erect. As will be explained more fully herein, the garment vest 10 of the present invention includes multiple handle holds thereon such that the caretaker 2 can grasp the patient 4 about multiple locations at the back of the patient, the front of the patient, or even the sides of the patient's torso so as to facilitate moving, lifting, or supporting the patient while the patient is moved about. It will be understood that the lift and gait assistance garment vest 10 of the present invention can equally as well be employed in transferring a person from a wheelchair to a bathroom stool, from a wheelchair to a bed or visa versa, into and out of a bathtub, into or out of an automobile or other type of conveyance and from moving from one position to another in a bed or stabilize a patient who is walking. Thus, the illustrated change in positions in FIGS. 1 and 2, seated to an upright position is by way of example only.

With reference now to FIGS. 1-8, the garment vest 10 embodying the present invention is shown. The garment 10 is made of a lightweight, but strong fabric. Preferably, the garment 10 is lined with a soft fabric on the inside which is comfortable to the wearer. As can be determined from the illustrations, and as will be known by one skilled in the art, the garment 10 of the present invention is configured as a vest, or as a sleeveless shirt, which is adapted and configured so as to be worn on an upper torso of the patient 4. As such, the garment vest 10 includes a front portion, which in a particularly preferred embodiment consists of a first front flap 12 and a second front flap 14 which are removably attached from one another, as can be seen in FIGS. 4 and 5. The garment vest 10 also includes a back portion 16, as illustrated in FIGS. 7 and 8. The back portion has a neckline 18 and the first front flap and the second front flap also include necklines 20 and 22 which cooperatively form a neck opening 24. An aperture formed in the garment 10 forms a right arm opening 26 and a second aperture formed in the garment forms a left arm opening 28. Shoulder areas 30 and 32 are defined in the garment 10 above the arm openings 26 and 28 and intermediate the necklines 18-22.

Preferably, the garment vest 10 is comprised of an exterior material which is easily cleaned, and yet interesting and fashionable. Typically, the neck opening 24 and arm openings 26 and 28 are sufficiently large so as to accommodate individuals of varying sizes. It will be appreciated that the garment vest 10 of the present invention can be manufactured in various sizes so as to accommodate different sized individuals, or as will be more fully explained herein, the garment vest 10 of the present invention is designed so as to be adjustable so as to fit snugly and tightly individuals which are of different sizes in height, girth, etc. As such, the garment vest 10 of the present invention can be either made in multiple sizes, or in a one-size-fits-all configuration, and adjusted to snugly fit each individual.

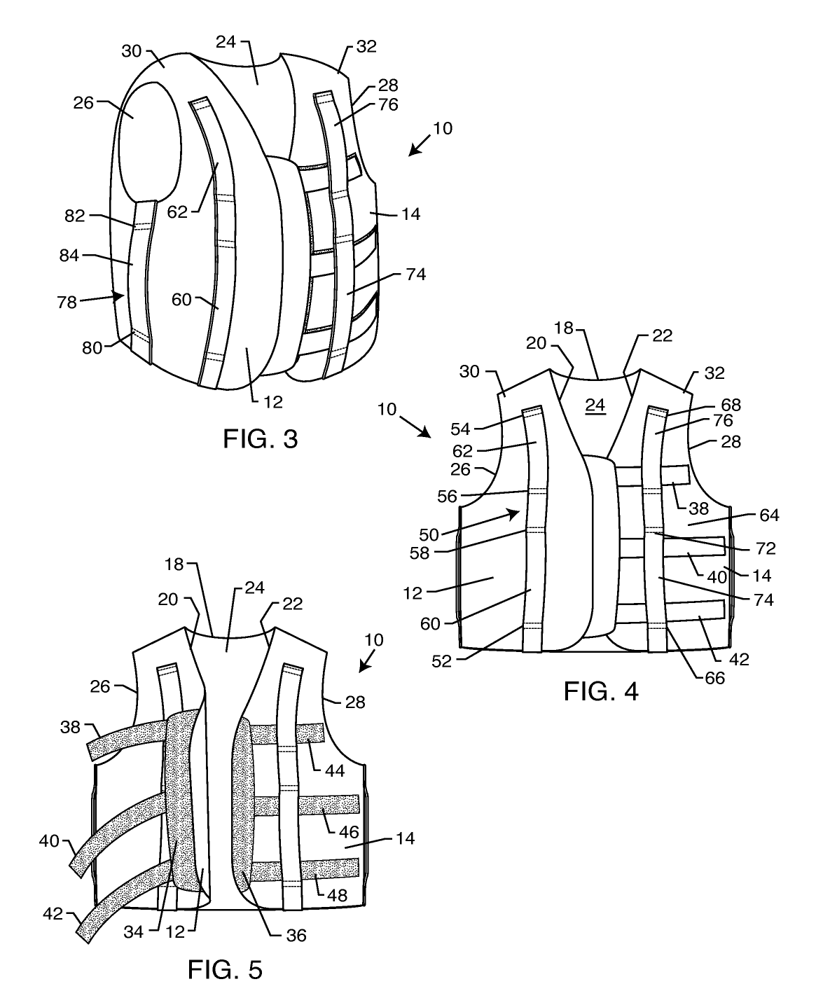

With reference now to FIGS. 3-5, in a preferred embodiment, the garment vest 10 has first and second front flaps 12 and 14, which are removably attached to one another. As it is an intention of the present invention to remove to the greatest extent possible hard plastic, metal, and other uncomfortable materials, such that the garment 10 can be worn for prolonged periods of time without discomfort, the preferred means of fastening the various components of the garment vest 10 are either by means of direct sewn attachment, or by means of hook and loop material (Velcro®). Although there are first and second front flap portions 12 and 14, a back portion 16, shoulder portions 30 and 32, etc., it will be understood by those skilled in the art that the garment vest 10 can be comprised of a single piece of fabric, or as panels which are sewn together to create the garment with the vest configuration.

With continuing reference to FIGS. 3-5, in a particularly preferred embodiment, the front flap portion 12 includes a hook or loop material segment 34, and the second front flap portion 14 includes a second corresponding hook or loop material segment on the second front flap portion 14, such that the segments 34 and 36 can be removably attached to one another. Typically, as illustrated in FIG. 5, the corresponding hook and loop material segments 34 and 36 are generally vertically oriented and extend from the necklines 20 and 22 to substantially a bottom edge of the front portion of the garment 10. This enables the full closure and attachment along a front of the garment vest 10, as illustrated in FIGS. 3 and 4.

With continuing reference to FIGS. 3-5, and particularly FIG. 5, a plurality of straps 38-42 each have a first end thereof attached, typically by sewing methods, to the first front flap 12. The remainder of the strap, including a second free end, extend outwardly from the garment 10. Corresponding hook or loop material elongated strips 44-48 are attached generally along the length thereof, such as by sewing techniques, to the second front flap 14 so as to be spaced apart from one another and extend generally horizontally along the front of width of the second front portion 14 of the vest 10. These elongated strips of hook or loop material 44-48 are positioned and are of a length so as to removably receive the elongated straps 38-42 thereon, as illustrated in FIGS. 3 and 5. It will also be appreciated that by using a plurality, typically three, such elongated straps 38-42 and strips 44-48 enables the vest 10 to be secured snugly at points generally across the sternum and below the armpits, along a waist portion, and intermediate those areas such that the garment vest is tightly and snugly fit upon the patient, which will prevent the garment vest 10 from slipping out of position, being pulled awkwardly over the arms or head of the patient, or the like when in use. The elongated nature of the straps 38-42 and strips 44-48 of hook and loop material also enable the garment vest 10 of the present invention to be adjusted to the size of different individuals.

As will be more fully described herein, the present invention provides a plurality of handle holds about the garment vest 10 such that a caregiver 2 can grasp the garment vest 10 at convenient locations, either at the front of the patient, the sides of the patient, or even the back of the patient, as need dictates, in order to move, lift, and support the patient 4. In accordance with the present invention, such handle holds are comprised of flexible and comfortable material, which are preferably devoid of hard plastic, metal, or other uncomfortable materials.

With reference again to FIGS. 3-5, at least one elongated strip of fabric, and preferably a plurality of strips of fabric are attached to the front portion of the garment 10 and which form handle holds. More particularly, an elongated strip of fabric is generally vertically oriented on the first front flap 12, so as to extend substantially the length thereof, and is attached at generally opposite first and second ends thereof 52 and 54 so as to form at least one handle hold. In a particularly preferred embodiment, the strap 50 is attached to the garment 10 intermediate the ends 52 and 54, such as at points 56 and 58 to form multiple handle holds 60 and 62, which are of sufficient size so as to enable an adult's hand to be inserted between the strip 50 and the underlying garment 10 and so as to grasp the handle holds 60 or 62 in a clenched fist.

It will be appreciated that the straps of material forming the handle holds are comprised of a strong and durable material, such as cotton strapping material, nylon woven web fabric, or the like. Both the strips of material forming the handle holds and the underlying garment vest need to be comprised of material which is sufficiently durable so as to resist tearing when the forces of moving, lifting or supporting an individual are exerted thereupon. Notwithstanding this, fabric is the preferred material which is sufficiently flexible and comfortable for the patient 4.

Similar to the first strip 50, a second strip 64 of such material has attachment points 66 and 68 at generally opposite ends thereof, and preferably also at intermediate points so as to form multiple hand holds 74 and 76.

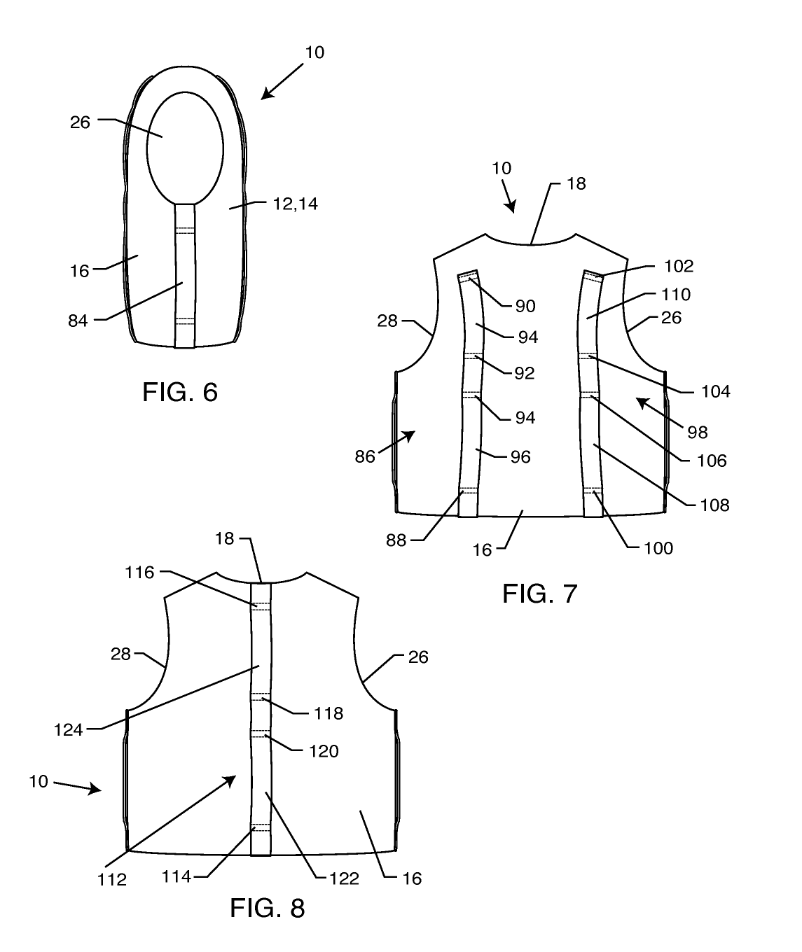

With reference now to FIGS. 3 and 6, at least one strip of material 78 is attached at generally first and second ends thereof 80 and 82 so as to extend substantially the length of the bottom edge of the garment 10 and the arm opening 26 and 28 so as to form a handle hold 84 along opposite sides of the garment vest 10.

With reference now to FIGS. 7 and 8, at least one elongated strip of material is attached to the back portion 16 of the garment vest 10 so as to form at least one back hand hold. In one embodiment, a first elongated strip of material is generally oriented vertically so as to extend substantially the length of the back portion and has a sewn attachment point 88 adjacent to a first end thereof and a second attachment point 90 adjacent a second end thereof 90, so as to form at least one handle hold therebetween. Similar to that described above, there are preferably at least one intermediate attachment point 92 and 94 which serve to form multiple back handle holds 94 and 96. As described above, the handle holds 94 and 96 are of sufficient length so that an adult can grasp the handle holds 94 and 96 with a clenched fist.

With continuing reference to FIG. 7, a second elongated strip of fabric 98 is attached to the back portion 16 of the garment vest 10 so as to extend substantially a length thereof, and is in spaced relation to the first elongated strip 86. Similar to that described above, the second elongated strip of fabric is attached to the underlying garment vest at generally a first end 100 thereof, as well as adjacent to a second end 102 thereof. Preferably, there is at least one intermediate attachment point 104 and 106, so as to create multiple handle holds 108 and 110. Of course, it will be understood by those skilled in the art, that multiple elongated strips of fabric can be used, end-to-end so as to create the multiple handle holds described herein. However, the use of a single elongated strip of fabric is more convenient and cost-effective in the manufacturing process.

With reference now to FIG. 8, in an alternative embodiment, a single elongated strip of fabric has an attachment point 114 adjacent to a first end thereof and a second attachment point 116 adjacent to a second end thereof. The elongated strip 112 extends generally vertically from the neckline 18 to a bottom edge of the garment vest 10, along a mid-line thereof, as illustrated in FIG. 8. This forms at least one back handle hold. However, as described above, it is preferred in the present invention that there are intermediate attachment points, such as 118 and 120 so as to create multiple handle holds 122 and 124. This enables the caregiver 2 to grasp adjacent to a waistline or small of the back of the patient, or upward toward the shoulder and neck area of the patient so as to stabilize, lift, move, etc. the patient 4.

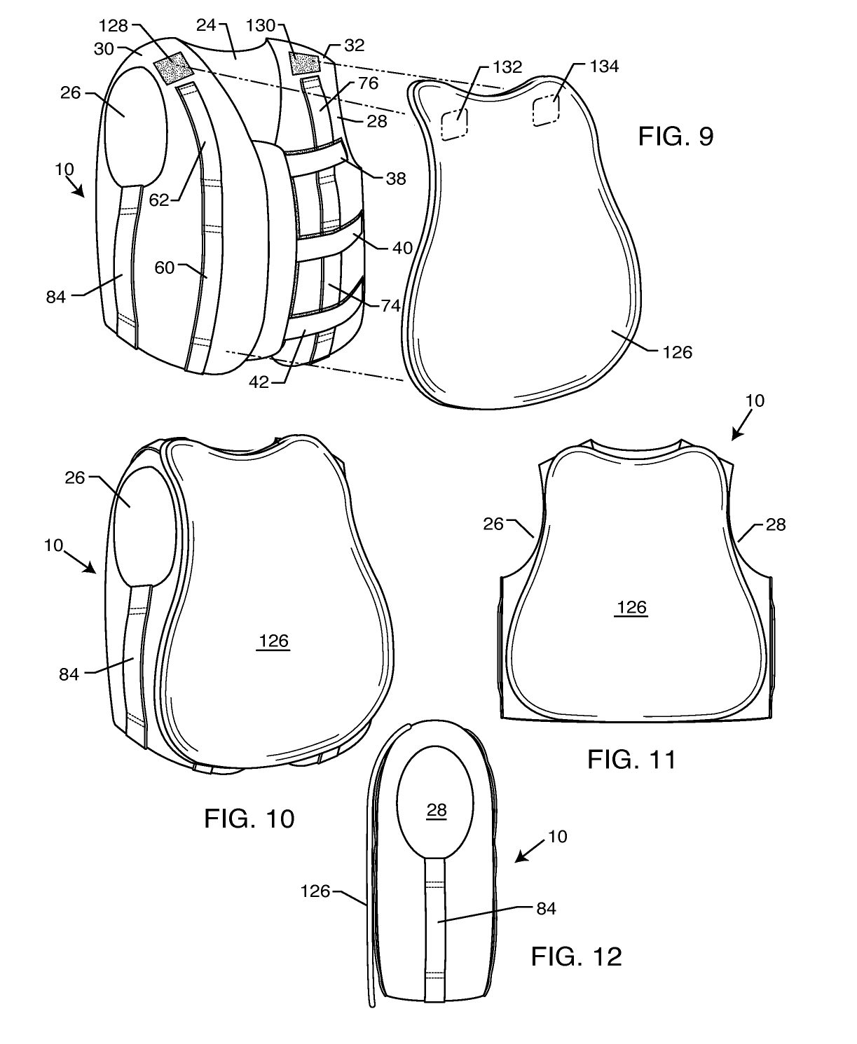

With reference now to FIGS. 9-12, in a particularly preferred embodiment, a bib 126 is removably attached to the front of the garment vest 10. Segments of hook or loop material 128 and 130 are attached to the garment vest 10, typically adjacent to the shoulder areas 30 and 32, or at other points of the first and second front flaps 12 and 14 of the garment vest 10. Corresponding segments of hook or loop material 132 and 134, illustrated in phantom in FIG. 9 are attached to the bib 126, such that the bib 126 can be attached to the garment vest, as illustrated in FIGS. 10-12, and hang securely therefrom, while enabling the easy attachment and removal thereof. It will be appreciated that the lift and gait assistance garment 10 of the present invention is often times used in association with the elderly, the incapacitated, or the like, wherein the caretaker 2 must assist the patient 4 during mealtimes, or the patient 4 is prone to creating messes. There may be instances outside of meals where such a protective bib 126 is desirable as well. The bib 126 is preferably comprised of either a material that can be easily washed, such as in a washing machine, or the material, such as vinyl, plastic, or the like which can be easily wiped clean. It is further contemplated that the bib 126 can be comprised of a material which is disposable. Such allows the bib 126 to be removed after feeding or the like, and cleaned or disposed of, without the need to clean the entire vest 10.

It will be appreciated by those skilled in the art that the lift and gait assistance garment vest 10 of the present invention can be fairly easily placed upon a patient. The corresponding hook and loop straps 38-48 can be adjusted to form a snug, but comfortable, fit on individuals of varying sizes. The provision of the multiple hand holds at the front, back, and each side of the garment 10 provide multiple places where the caretaker can grasp, lift and support the patient. The use of complicated buckles, loops, and the like are eliminated which would otherwise be used to adjust straps and the like. Moreover, the elimination of such buckles and clamps render the vest 10 of the present invention much more comfortable to wear to the patient, and thus the garment vest 10 of the present invention can be used for extended periods of time. In fact, as there are no large and hard items attached to the garment 10, such as buckles and clamps or the like, the garment 10 of the present invention can be worn throughout the entire day, such that the patient can even sleep in the garment 10 and have a similar degree of comfort as wearing a shirt or the like. However, the garment vest 10 can be snugly and securely fastened and fitted to the individual in order to form the necessary support and movement of the patient. As will be appreciated by those skilled in the art, if the garment 10 is too loose, then the garment 10 will tend to move upwardly during use, which is undesirable as the caregiver will have difficulty in holding and supporting the patient. However, if the garment vest 10 is too tight, then the patient will be uncomfortable. The hook and loop fasteners 38-48 of the present invention enable the fit to be easily and quickly adjusted to suit both the needs of the caregiver 2 as well as the patient 4.

Although several embodiments have been described in detail for purposes of illustration, various modifications may be made without departing from the scope and spirit of the invention. Accordingly, the invention is not to be limited, except as by the appended claims.

What is claimed is:

1. A patient lift and gait assistance garment, comprising:
a fabric garment having a vest configuration, with a back portion and a front portion, the back portion and the front portion each having a neckline cooperatively forming a neck opening, a first aperture formed in the garment defining a right arm opening, a second aperture formed in the garment defining a left arm aperture,
at least one elongated strip of fabric having first and second ends attached to the front portion of the garment for form at least one front handle hold;
at least one elongated strip of fabric having first and second ends attached to the back portion of the garment to form at least one back handle hold;
at least one elongated strap of fabric having a first end attached to the garment and a second free end extending from the garment and having hook or loop material on a surface thereof; and
at least one second elongated strip of hook or loop material attached generally along a length thereof to the front portion of the garment, whereby the free end of the at least one elongated strap of fabric is brought over and attached to the at least one elongated strip of hook and loop material so as to tighten the garment on the patient.

2. The garment of claim 1, wherein the at least one elongated strip of fabric forming the back handle hold is attached to the back portion of the garment intermediate the ends thereof to form multiple back handle holds.

3. The garment of claim 1, wherein the at least one elongated strip of fabric forming the at least one back handle hold comprises a plurality of vertically oriented and spaced apart elongated strips of fabric attached to the back portion of the garment and forming at least one handle hold in each strip.

4. The garment of claim 3, wherein the plurality of strips of fabric forming the back handle holds extend from a first end attached to the garment adjacent a bottom edge of the back portion to a second end attached to a shoulder portion of the garment.

5. The garment of claim 1, wherein the at least one elongated strip forming the at least one back handle comprises a single strip of fabric extending generally along a mid-line from adjacent to a bottom edge of the back portion to the neckline of the back portion.

6. The garment of claim 1, including a strip of fabric attached to the garment at generally opposite ends thereof and disposed below the right and the left arm openings to form side handle holds.

7. The garment of claim 1, wherein the front portion comprises first and second front flaps which are removably attachable to one another.

8. The garment of claim 7, wherein the first flap includes a segment of hook or loop material and the second flap includes a corresponding segment of hook or loop material for removable connection of the first and second flaps.

9. The garment of claim 7, wherein the first end of the at least one strap is attached to the first flap, and wherein the corresponding at least one strip of hook or loop material is attached to the second flap.

10. The garment of claim 9, wherein the at least one strap comprises a plurality of straps each having a first end attached to the first flap in spaced apart relation.

11. The garment of claim 10, wherein the at least one strip of hook or loop material comprise a plurality of strips attached to the second front flap in spaced relation corresponding to the plurality of straps, and having a generally horizontal orientation, so as to be configured to receive the straps thereon.

12. The garment of claim 7, wherein the at least one strip of fabric forming the at least one front handle hold comprises a strip of fabric vertically oriented on the first front flap and a strip of fabric vertically oriented on the second flap.

13. The garment of claim 12, wherein the strips of fabric attached to the first and second front flaps are each attached intermediate the ends thereof to form multiple front handle holds

14. The garment of claim 1, including a bib removably attached to the front portion of the garment.

15. A patient lift and gait assistance garment, comprising:
a fabric garment having a vest configuration, with a back portion and a first front flap portion and a second front flap portion, the first and second front flap portions each including hook or loop material so as to be removably attached to one another, the back portion and the first and second front flap portions each having a neckline cooperatively forming a neck opening, a first aperture formed in the garment defining a right arm opening, a second aperture formed in the garment defining a left arm aperture,
at least one elongated strip of fabric having first and second ends attached to the back portion of the garment so as to be vertically oriented and extend substantially a length of the back portion and forming at least one back handle hold;
an elongated strip of fabric having first and second ends attached to the first front flap portion of the garment so as to be vertically oriented and extend substantially a length of the first flap portion and forming at least one front handle hold;
an elongated strip of fabric having first and second ends attached to the second front flap portion of the garment so as to be vertically oriented and extend substantially a length of the second flap portion and forming at least one front handle hold;
a strip of fabric attached to the garment at generally opposite ends thereof and disposed below the right and the left arm openings to form side handle holds;
a plurality of elongated straps of fabric having first ends attached to either the first or second front flap and second free ends extending from the first or second flap and having hook or loop material on a surface of each; and
a plurality of second hook or loop material elongated strips attached generally along a length thereof to the corresponding first or second front flap portion of the garment, whereby the free ends of the elongated straps of fabric are brought over and attached to the corresponding elongated strips of hook and loop material so as to tighten the garment on the patient.

16. The garment of claim 15, wherein the at least one elongated strip of fabric forming the back handle hold are attached to the back portion of the garment intermediate the ends thereof to form multiple back handle holds.

17. The garment of claim 16, wherein the at least one elongated strip of fabric forming the at least one back handle hold comprises a plurality of vertically oriented and spaced apart elongated strips of fabric attached to the back portion of the garment.

18. The garment of claim 16, wherein the at least one elongated strip forming the at least one back handle comprises a strip of fabric extending generally along a mid-line from adjacent to a bottom edge of the back portion to the neckline of the back portion.

19. The garment of claim 15, wherein the strips of fabric attached to the first and second front flaps are each attached intermediate the ends thereof to form multiple front handle holds in each strip.

20. The garment of claim 15, including a bib removably attached to the garment and configured to substantially cover the first and second flaps of the front portion of the garment.
